(19) United States
(12) Patent Application Publication
(10) Pub. No.: US 2012/0208161 A1
(43) Pub. Date: Aug. 16, 2012

(54) MISDIAGNOSIS CAUSE DETECTING APPARATUS AND MISDIAGNOSIS CAUSE DETECTING METHOD

(76) Inventors: Kazutoyo TAKATA, Osaka (JP); Takashi Tsuzuki, Osaka (JP)

(21) Appl. No.: 13/454,239

(22) Filed: Apr. 24, 2012

Related U.S. Application Data
(63) Continuation of application No. PCT/JP2011/004780, filed on Aug. 29, 2011.

(30) Foreign Application Priority Data
Sep. 7, 2010 (JP) 2010-200373

(51) Int. Cl. G09B 23/28

(52) U.S. Cl. 434/262

(57) ABSTRACT

An image interpretation training apparatus comprises: an image presenting unit configured to present a target image to be interpreted to a doctor; an image interpretation obtaining unit configured to obtain a first image interpretation of the target image by the doctor and image interpretation time required by the doctor for the interpretation of the target image; an image interpretation determining unit configured to determine whether the first image interpretation is correct or incorrect by comparing a definitive diagnosis on the target image and the first image interpretation obtained by the image interpretation obtaining unit; and a learning content attribute selecting unit configured to select an attribute of the learning content to be presented to the doctor based on the image interpretation time when the first image interpretation result is determined to be incorrect.

### CROSS REFERENCE TO RELATED APPLICATIONS

This is a continuation application of PCT Patent Application No. PCT/JP2011/004780 filed on Aug. 29, 2011, designating the United States of America, which is based on and claims priority of Japanese Patent Application No. 2010-200373 filed on Sep. 7, 2010. The entire disclosures of the above-identified applications, including the Specifications, Drawings and Claims are incorporated herein by reference in their entirety.

### TECHNICAL FIELD

Apparatuses and methods consistent with exemplary embodiments of the present disclosure relate generally to a misdiagnosis cause detecting apparatus and a misdiagnosis cause detecting method.

### BACKGROUND ART

In order to prevent misdiagnoses by doctors (hereinafter users such as doctors and radiologists may be simply referred to as doctors), there have been methods for determining a possibility of a misdiagnosis based on an image interpretation time (a time period required by the doctor for the interpretation of images). The method disclosed in Patent Literature (PTL) 1 calculates a reference image interpretation time from an image interpretation database storing past data, and determines that there is a possibility of a misdiagnosis when a target image interpretation time exceeds the reference image interpretation time. In this way, it is possible to make immediate determinations on misdiagnoses for some of cases.

### CITATION LIST

### Patent Literature

### [PTL 1]

Japanese Unexamined Patent Application Publication No. 2009-82182

### SUMMARY OF INVENTION

### Technical Problem

However, the method disclosed in Patent Literature (PTL) 1 is incapable of detecting the cause of a misdiagnosis.

### Solution to Problem

One or more exemplary embodiments of the present disclosure may overcome the above disadvantage and other disadvantages not described above. However, it is understood that one or more exemplary embodiments of the present disclosure are not required to overcome or may not overcome the disadvantage described above and other disadvantages not described above. One or more exemplary embodiments of the present disclosure provide a misdiagnosis cause detecting apparatus and a misdiagnosis detecting method for detecting the cause of a misdiagnosis when the misdiagnosis was made by a doctor.

According to an exemplary embodiment of the present disclosure, a misdiagnosis cause detecting apparatus comprises: an image presenting unit configured to present, to a user, a target image to be interpreted that is used to make an image-based diagnosis on a case and is paired with a definitive diagnosis in an image interpretation report, the target image being one of interpreted images used for image-based diagnoses and respectively included in image interpretation reports; an image interpretation obtaining unit configured to obtain a first image interpretation that is an interpretation of the target image by the user and an image interpretation time that is a time period required by the user for the interpretation of the target image, the first image interpretation including an indication of a name of the disease; an image interpretation determining unit configured to determine whether the first image interpretation obtained by the image interpretation obtaining unit is correct or incorrect by comparing the first image interpretation with the definitive diagnosis on the target image; and a learning content attribute selecting unit configured to execute, when the first image interpretation is determined to be incorrect by the image interpretation determining unit, at least one of: (a) a first selection process for selecting an attribute of a first learning content to be presented to the user when the image interpretation time obtained by the image interpretation obtaining unit is longer than a threshold value, the first learning content being for learning a diagnosis flow for the case having the disease name indicated by the first image interpretation; and (b) a second selection process for selecting an attribute of a second learning content to be presented to the user when the image interpretation time obtained by the image interpretation obtaining unit is shorter than or equal to the threshold value, the second learning content being for learning an image pattern of the case having the disease name indicated by the first image interpretation.

It is to be noted that each of general or specific embodiments of the present disclosure may be implemented or realized as a system, a method, an integrated circuit, a computer program, or a recording medium, and that (each of) the specific embodiments may be implemented or realized as an arbitrary combination of (parts of) a system, a method, an integrated circuit, a computer program, or a recording medium.

### Advantageous Effects of Invention

According to various exemplary embodiments of the present disclosure, it is possible to detect the cause of a misdiagnosis when the misdiagnosis was made by a doctor.

### BRIEF DESCRIPTION OF DRAWINGS

These and other objects, advantages and features of exemplary embodiments of the present disclosure will become apparent from the following description thereof taken in conjunction with the accompanying Drawings that illustrate general and specific exemplary embodiments of the present disclosure. In the Drawings:

FIG. 1 is a block diagram of unique functional elements of an image interpretation training apparatus according to Embodiment 1 of the present disclosure;

FIG. 2A is a diagram of examples of ultrasonic images as interpreted images stored in an image interpretation report database;

FIG. 2B is a diagram of an example of image interpretation information stored in the image interpretation report database;

FIG. 3 is a diagram of examples of images presented by an image presenting unit;

FIG. 4 is a diagram of a representative image and an example of an image interpretation flow;

FIG. 5 is a diagram of an example of a histogram of image interpretation time;

FIG. 6 is a diagram of an example of a learning content database;

FIG. 7 is a flowchart of all processes executed by the image interpretation training apparatus according to Embodiment 1 of the present disclosure;

FIG. 8 is a flowchart of details of a learning content attribute selecting process (Step S105 in FIG. 7) by the learning content attribute selecting unit;

FIG. 9 is a diagram of an example of an image screen output to an output medium by an output unit;

FIG. 10 is a diagram of an example of an image screen output to an output medium by an output unit;

FIG. 11 is a block diagram of unique functional elements of an image interpretation training apparatus according to Embodiment 2 of the present disclosure;

FIG. 12A is a diagram of an example of a misdiagnosis portion on an interpreted image;

FIG. 12B is a diagram of an example of a misdiagnosis portion in a diagnosis flow;

FIG. 13 is a flowchart of all processes executed by the image interpretation training apparatus according to Embodiment 2 of the present disclosure;

FIG. 14 is a flowchart of details of a misdiagnosis portion extracting process (Step S301 in FIG. 13) by a misdiagnosis portion extracting unit;

FIG. 15 is a diagram of examples of representative images and diagnosis items of two cases;

FIG. 16 is a diagram of an example of an image screen output to an output medium by an output unit; and

FIG. 17 is a diagram of an example of an image screen output to an output medium by an output unit.

### DESCRIPTION OF EMBODIMENTS

### Underlying Knowledge Forming Basis of the Present Disclosure

The inventors found that the misdiagnosis possibility determining method disclosed in the section of “Background Art” has the following disadvantage.

Due to recent chronic lack of doctors, doctors who have little experience of image interpretations make misdiagnoses. Such misdiagnoses become increasingly problematic. Among such misdiagnoses, “a false negative diagnosis (an overlook)” and “a misdiagnosis (an underdiagnosis or an overdiagnosis)” heavily affect the patient's prognosis. The false negative diagnosis is an overlook of a lesion. The misdiagnosis is an underdiagnosis or an overdiagnosis of a detected lesion.

In order to prevent such misdiagnoses, cause-based countermeasures against the misdiagnoses are taken. Approaches taken for the “false negative diagnoses” include a detection support by Computer Aided Diagnosis (CAD) for an automatic detection of a lesion zone by a computer. This is effective for the prevention of overlooks of lesions.

On the other hand, as for the “misdiagnosis (underdiagnosis or overdiagnosis)”, skilled doctors provide image interpretation training as such countermeasures. For example, a skilled doctor teaches a fresh doctor how to make a determination on whether a diagnosis is correct or incorrect, and how to prevent a misdiagnosis according to the cause of the misdiagnosis if the fresh doctor makes a misdiagnosis. For example, if the fresh doctor misdiagnoses Cancer A as another cancer because he or she made the misdiagnosis using a wrong diagnosis flow different from a right diagnosis flow for determining Cancer A, the skilled doctor teaches the fresh doctor the right diagnosis flow. On the other hand, if the fresh doctor misdiagnoses Cancer A as another cancer because he or she made the misdiagnosis using wrong image patterns which do not correspond to the right diagnosis flow for determining Cancer A, the skilled doctor teaches the fresh doctor the right image patterns.

Here, the causes of a misdiagnosis on a case are roughly divided into two. The first cause is that the case is incorrectly associated with a wrong diagnosis flow. The second cause is that the case is incorrectly associated with wrong image patterns.

The reason why these causes of the misdiagnoses are classified into the above two types stems from the fact that the process for learning an image interpretation technique are divided into two stages.

At the initial stage of the learning process, a fresh doctor learns the diagnosis flow of each of cases, and makes a diagnosis on the case according to the diagnosis flow. At this stage, the diagnosis is made after checking each of diagnosis items included in the diagnosis flow. At the next stage, the fresh doctor memorizes image patterns of the case in a direct association with the case, and makes a diagnosis by performing image pattern matching. In other words, a misdiagnosis by a doctor results from wrong knowledge obtained in any of the aforementioned learning process.

Thus, if a misdiagnosis is made by a doctor, there is a need to determine whether the misdiagnosis is caused by “a wrong association between a case and a diagnosis flow” or by “a wrong association between a case and image patterns”, and present the determined cause to the doctor.

One or more exemplary embodiments of the present disclosure provide a misdiagnosis cause detecting apparatus capable of determining whether a misdiagnosis is caused by “a wrong association between a case and a diagnosis flow” or by “a wrong association between a case and image patterns” if the misdiagnosis is made by a doctor, and present the determined cause to the doctor.

Hereinafter, exemplary embodiments of the present disclosure are described in greater detail with reference to the accompanying Drawings. Each of the exemplary embodiments described below shows a generic or specific example in the present disclosure. The numerical values, shapes, materials, structural elements, the arrangement and connection of the structural elements, steps, the processing order of the steps etc. shown in the following exemplary embodiments are mere examples, and therefore do not limit the present disclosure which is defined according to the Claims. Therefore, among the structural elements in the following exemplary embodiments, the structural elements not recited in any one of the independent Claims defining the most generic concept of the present disclosure are not necessarily required to overcome (a) conventional disadvantage(s).

According to an exemplary embodiment of the present disclosure, if a doctor misdiagnoses a case by interpreting images such as ultrasonic images, Computed Tomography (CT) images, and magnetic resonance images, a misdiagnosis cause detecting apparatus is intended to determine whether the misdiagnosis is caused by associating wrong image patterns with the case or by associating a wrong diagnosis flow with the case, based on an input definitive diagnosis (hereinafter also referred to as an “image interpretation result”) and a diagnosis time (hereinafter also referred to as an “image interpretation time”), and present a learning content suitable for the cause of the misdiagnosis by the doctor.

A misdiagnosis according to an embodiment of the present disclosure cause detecting apparatus comprises: an image presenting unit configured to present, to a user, a target image to be interpreted that is used to make an image-based diagnosis on a case and is paired with a definitive diagnosis in an image interpretation report, the target image being one of interpreted images used for image-based diagnoses and respectively included in image interpretation reports; an image interpretation obtaining unit configured to obtain a first image interpretation that is an interpretation of the target image by the user and an image interpretation time that is a time period required by the user for the interpretation of the target image, the first image interpretation including an indication of a name of the disease; an image interpretation determining unit configured to determine whether the first image interpretation obtained by the image interpretation obtaining unit is correct or incorrect by comparing the first image interpretation with the definitive diagnosis on the target image; and a learning content attribute selecting unit configured to execute, when the first image interpretation is determined to be incorrect by the image interpretation determining unit, at least one of: (a) a first selection process for selecting an attribute of a first learning content to be presented to the user when the image interpretation time obtained by the image interpretation obtaining unit is longer than a threshold value, the first learning content being for learning a diagnosis flow for the case having the disease name indicated by the first image interpretation; and (b) a second selection process for selecting an attribute of a second learning content to be presented to the user when the image interpretation time obtained by the image interpretation obtaining unit is shorter than or equal to the threshold value, the second learning content being for learning an image pattern of the case having the disease name indicated by the first image interpretation.

The causes of misdiagnoses can be classified based on image interpretation times. If “a wrong association between a case and a diagnosis flow” is made by a doctor, the doctor makes a diagnosis by sequentially checking the diagnosis flow, and thus a feature that the image interpretation time is long is found. On the other hand, if “a wrong association between a case and image patterns” is made by a doctor, it is considered that the doctor has already learned and thus sufficiently knows the diagnosis flow. For this reason, the doctor makes a diagnosis based mainly on the image patterns associated with the target case because there is no need to check the diagnosis flow for the target case. Thus, in the latter case, the image interpretation time is short. Therefore, it is possible to determine the cause of the misdiagnosis as resulting from “a wrong association between a case and a diagnosis flow” if the image interpretation time is long, and to determine the cause of the misdiagnosis as resulting from “a wrong association between a case and image patterns” if the image interpretation time is short.

In this way, it is possible to determine which one of the diagnosis flow and image patterns is the cause of the misdiagnosis based on the image interpretation time, and to thereby automatically select the attribute of the learning content according to the cause of the misdiagnosis. According to the attribute of the selected learning content, the doctor can select the learning content which helps the doctor correct wrong knowledge that is the cause of the misdiagnosis. In addition, it is possible to reduce time for searching out a learning content to be referred to in the case of a misdiagnosis, and to reduce learning time required by the doctor.

In other words, when the image interpretation time is longer than a threshold value, it is possible to determine the occurrence of “a wrong association between a case and a diagnosis flow”. For this reason, it is possible to select the attribute of the learning content for learning the diagnosis flow. In this way, the doctor can select the learning content which helps the doctor correct the wrong diagnosis flow that is the cause of the misdiagnosis. In addition, the doctor can immediately search out the learning content for learning the diagnosis flow as the learning content to be referred to in the case of a misdiagnosis, and to reduce learning time required by the doctor.

When the image interpretation time is shorter than or equal to the threshold value, it is possible to determine the occurrence of “a wrong association between a case and image patterns”. For this reason, it is possible to select the attribute of the learning content for learning the image patterns. In this way, the doctor can select the learning content which helps the doctor correct the wrong image patterns that are the cause of the misdiagnosis. In addition, the doctor can immediately search out the learning content for learning the image patterns as the learning content to be referred to in making a diagnosis, and to reduce learning time required by the doctor.

In addition, the image interpretation report may further include a second image interpretation that is a previously-made image interpretation of the target image, and the image presenting unit is configured to present, to the user, the target image included in the image interpretation report that includes the definitive diagnosis and the second image interpretation that match each other.

An image interpretation report database includes interpreted images which do not solely enable a doctor to find out a lesion which matches a definitive diagnosis due to image noise or characteristics of an imaging apparatus used to capture the interpreted image. Such images are inappropriate as images for use in image interpretation training provided with an aim to enable finding of a lesion based only on the images. In contrast, cases having a definitive diagnosis and a second image interpretation which match each other are cases which guarantee that the same lesion as the lesion obtained in the definitive diagnosis can be found in the interpreted images. Accordingly, it is possible to present only images of cases necessary for image interpretation training by selecting only such interpreted images having a definitive diagnosis and a second image interpretation which match each other.

In addition, the misdiagnosis cause detecting apparatus may further comprise an output unit configured to obtain, from a learning content database, one of the first learning content and the second learning content which has the attribute selected by the learning content attribute selecting unit for the case having the disease name indicated by the first image interpretation, and output the obtained first or second learning content, the learning content database storing first learning contents for learning diagnosis flows for cases and second learning contents for learning image patterns of the cases such that the first learning contents are associated with cases and the second learning contents are associated with the cases.

In this way, obtaining and outputting the learning content of the selected attribute make it possible to reduce labor required by a doctor for the search-out of the learning content.

In addition, the image interpretation report may further include results of determinations made on diagnosis items, and the image interpretation obtaining unit may further be configured to obtain the determination results on the respective diagnosis items made by the user, the misdiagnosis cause detecting apparatus may further comprise a misdiagnosis portion extracting unit configured to extract each of at least one of the diagnosis items which corresponds to a misdiagnosis portion in the first or second learning content and is related to a difference of one of the determination results obtained by the image interpretation obtaining unit with respect to a corresponding one of the determination results included in the image interpretation report.

With this structure, it is possible to extract the items related to the misdiagnosis by the doctor.

In addition, the misdiagnosis cause detecting apparatus may further comprise an output unit configured to obtain, from a learning content database, one of the first learning content and the second learning content which has the attribute selected by the learning content attribute selecting unit for the case having the disease name indicated by the first image interpretation, emphasize, in the obtained first or second learning content, the misdiagnosis portion corresponding to the diagnosis item extracted by the misdiagnosis portion extracting unit, and output the obtained first or second learning content with the emphasized portion the learning content database storing first learning contents for learning diagnosis flows for cases and second learning contents for learning image patterns of the cases such that the first learning contents are associated with cases and the second learning contents are associated with the cases.

With this structure, it is possible to present the learning content with emphasized misdiagnosis portions in relation to which the misdiagnosis was made by the doctor. In this way, it is possible to reduce the time to detect the misdiagnosis portions. Thus, reducing the number of overlooks of misdiagnosis portions and the time for searching out misdiagnosis portions make it possible to increase the learning efficiency of the doctor.

In addition, the threshold value may be associated one-to-one with the case having the disease name indicated by the first image interpretation.

Setting a different threshold value for each of cases makes it possible to increase the accuracy in the selection of the attribute of the learning content by the learning content attribute selecting unit.

Hereinafter, descriptions are given of misdiagnosis cause detecting apparatuses and misdiagnosis cause detecting methods according to exemplary embodiments of the present disclosure. The misdiagnosis cause detecting apparatus in each of the exemplary embodiments of the present disclosure is applied to a corresponding image interpretation training apparatus for a doctor. However, the misdiagnosis cause detecting apparatus is applicable to image interpretation training apparatuses other than the image interpretation training apparatuses in the exemplary embodiments of the present disclosure.

For example, the misdiagnosis cause detecting apparatus may be an apparatus which detects the cause of a misdiagnosis which is actually about to be made by a doctor in an ongoing diagnosis based on image interpretation, and present the cause of the misdiagnosis to the doctor.

Hereinafter, exemplary embodiments of the present disclosure are described in greater detail with reference to the accompanying Drawings.

### EMBODIMENT 1

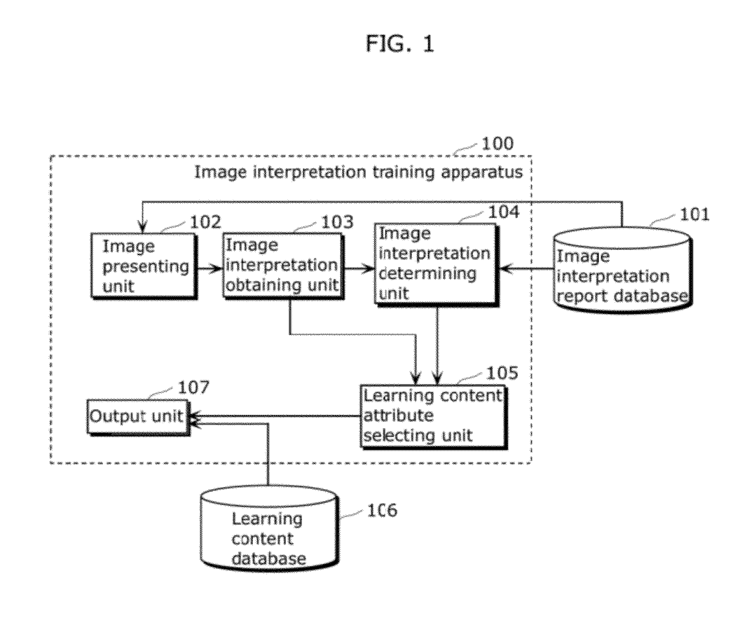

FIG. 1 is a block diagram of unique functional elements of an image interpretation training apparatus 100 according to Embodiment 1 of the present disclosure. As shown in FIG. 1, the image interpretation training apparatus 100 is an apparatus which presents a learning content according to the result of an image interpretation by a doctor. The image interpretation training apparatus 100 includes: an image interpretation report database 101, an image presenting unit 102, an image interpretation obtaining unit 103, an image interpretation determining unit 104, a learning content attribute selecting unit 105, a learning content database 106, and an output unit 107.

Hereinafter, structural elements of the image interpretation training apparatus 100 shown in FIG. 1 are sequentially described in detail.

The image interpretation report database 101 is a storage device including, for example, a hard disk, a memory, or the like. The image interpretation report database 101 is a database which stores interpreted images that are presented to doctors, and image interpretation information corresponding to the interpreted images. Here, the interpreted images are images which are used for diagnoses based on images and stored in an electric medium. In addition, image interpretation information is information which shows image interpretations of the interpreted images and the definitive diagnosis such as the result of biopsy carried out after the diagnosis based on the images.

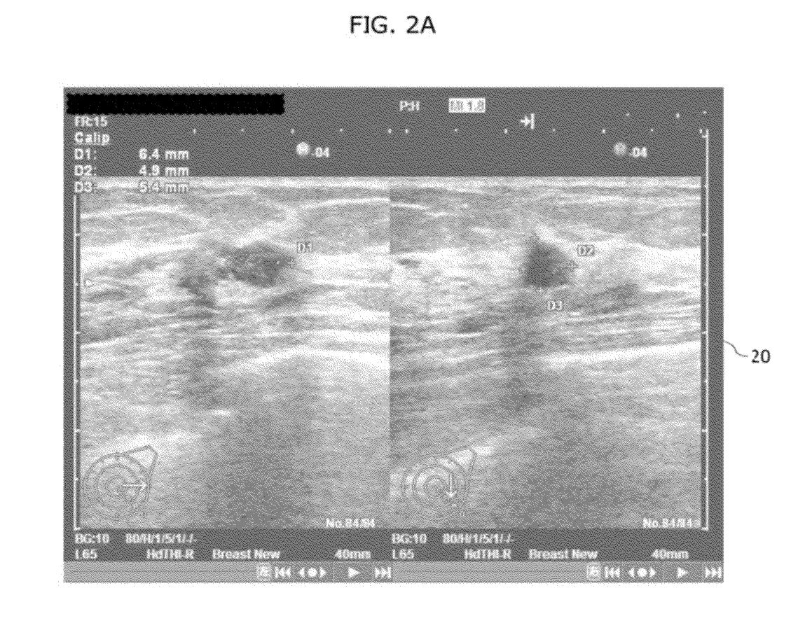

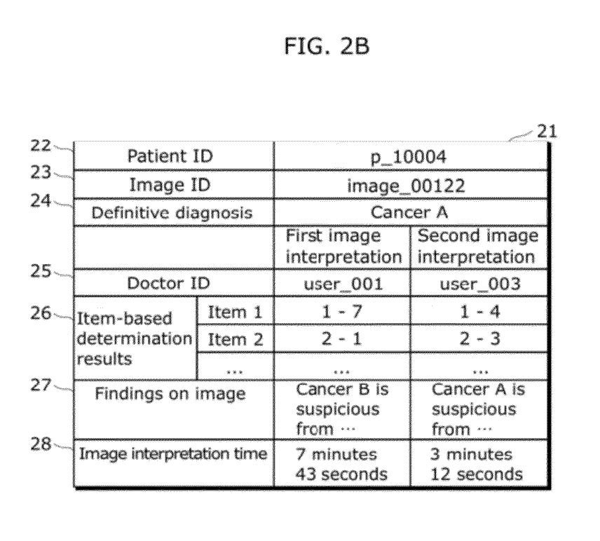

Each of FIG. 2A and FIG. 2B shows an example of an ultrasonic image as an interpreted image 20 and image interpretation information 21 stored in the image interpretation report database 101. The image interpretation information 21 includes: patient ID 22, image ID 23, a definitive diagnosis 24, doctor ID 25, item-based determination results 26, findings on image 27, and image interpretation time 28.

The patient ID 22 is information for identifying a patient who is a subject of the interpreted image. The image ID 23 shows information for identifying the interpreted image 20. The definitive diagnosis 24 is the final result of the diagnosis for the patient identified by the patient ID 22. Here, the definitive diagnosis is the result of diagnosis which is made by performing various kinds of means such as a pathologic test on a test body obtained in a surgery or a biopsy using a microscope and which clearly shows the true body condition of the subject patient. The doctor ID 25 is information for identifying the doctor who interpreted the interpreted image 20 having the image ID 23. The item-based determination results 26 are information items indicating the results of determinations made based on diagnosis items (described as Item 1, Item 2, and the like in FIG. 2B) predetermined for the interpreted image 20 having the image ID 23. For example, in the case where the interpreted image 20 having the image ID 23 is an image showing a mammary gland, the diagnosis items correspond to a border appearance (clear and smooth, clear and irregular, unclear, or difficult to differentiate) and an internal echo level (free, very low, low, equal, or high). The findings on image 27 are information indicating the result of a diagnosis made by the doctor having the doctor ID 25 based on the interpreted image 20 having the image ID 23. The findings on image 27 are information indicating the diagnosis result (image interpretation) including the name of a disease and the diagnostic reasons (the bases of image interpretation). The image interpretation time 28 is information showing time from the starting time of an image interpretation and the ending time of the image interpretation.

In the case where a plurality of doctors interpret the interpreted image 20 having image ID 23, such doctor ID 25, item-based determination results 26, findings on image 27, and image interpretation time 28 are stored for each doctor ID 25.

In this exemplary embodiment, the image interpretation report database 101 is included in the image interpretation training apparatus 100. However, image interpretation training apparatuses to which one of exemplary embodiments of the present disclosure is applicable are not limited to the image interpretation training apparatus 100. For example, the image interpretation report database 101 may be provided on a server which is connected to the image interpretation training apparatus via a network.

Alternatively, the image interpretation information 21 may be included in an interpreted image 20 as supplemental data.

Here, a return is made to the descriptions of the respective structural elements of the image interpretation training apparatus 100 shown in FIG. 1.

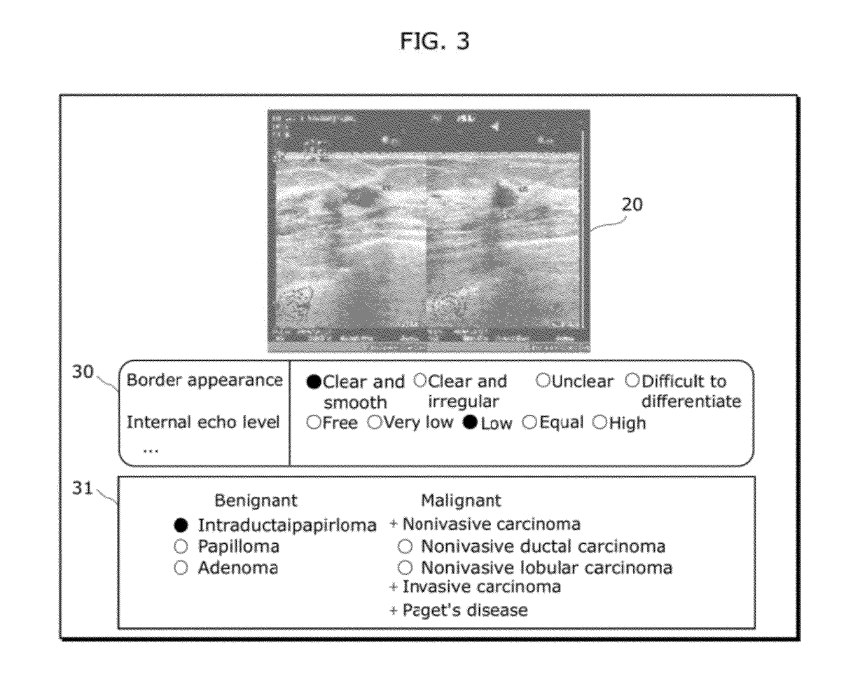

The image presenting unit 102 obtains an interpreted image 20 as a target image to be interpreted in a diagnosis test, from the image interpretation report database 101. In addition, the image presenting unit 102 presents, to a doctor, the obtained interpreted image 20 (the target image to be interpreted) together with an entry form on which diagnosis items and findings on image for the interpreted image 20 are input, by displaying the interpreted image 20 and the entry form on a monitor such as a liquid crystal display and a television receiver (not shown). FIG. 3 is a diagram of an example of an image presented by the image presenting unit 102. As shown in FIG. 3, a presentation screen presents: the interpreted image 20 that is the target of the diagnosis test; an entry form, such as a diagnosis item entry area 30, as an answer form for the results of the determinations made on the diagnosis items; and an entry form, such as an image findings entry area 31, as an entry form for the findings on image (the interpreted image 20). The diagnosis item entry area 30 includes items corresponding to the item-based determination results 26 in the image interpretation report database 101. On the other hand, the image findings entry area 31 includes items corresponding to the findings on image 27 in the image interpretation report database 101.

The image presenting unit 102 may select only an interpreted image 20 having a definitive diagnosis 24 and findings on image 27 which match each other when obtaining the interpreted image 20 that is a target image to be interpreted in a diagnosis test, from the image interpretation report database 101. The image interpretation report database 101 includes interpreted images 20 which do not solely enable a doctor to find out a lesion which matches a definitive diagnosis due to image noise or characteristics of an imaging apparatus used to capture the interpreted images 20. Such images are inappropriate as images for use in image interpretation training provided with an aim to enable finding of a lesion based only on the interpreted images 20. In contrast, cases having a definitive diagnosis 24 and findings on image 27 which match each other are cases which guarantee that the same lesion as the lesion obtained in the definitive diagnosis can be found in the interpreted images 20. Thus, it is possible to present only images of cases necessary for image interpretation training by selecting only such interpreted images 20 having a definitive diagnosis 24 and findings on an image 27 which match each other. In the case where a plurality of doctors interprets the interpreted image 20 and when one of the findings on image 27 of a first doctor and the findings on image 27 of a second doctor matches the definitive diagnosis 24, it is possible to select only the interpreted image 20 having the image ID 23.

The image interpretation obtaining unit 103 obtains the image interpretation by the doctor on the interpreted image 20 presented by the image presenting unit 102. For example, the image interpretation obtaining unit 103 obtains information that is input to the diagnosis item entry area 30 and the image findings entry area 31 via a keyboard, a mouse, or the like. In addition, the image interpretation obtaining unit 103 obtains time (image interpretation time) from the starting time of the image interpretation to the ending time of the image interpretation by the doctor. The image interpretation obtaining unit 103 outputs the obtained information and the image interpretation time to the image interpretation determining unit 104 and the learning content attribute selecting unit 105. The image interpretation time is measured using a timer (not shown) provided in the image interpretation training apparatus 100.

The image interpretation determining unit 104 determines whether the image interpretation by the doctor is correct or incorrect by comparing the image interpretation by the doctor obtained from the image interpretation obtaining unit 103 with the image interpretation information 21 stored in the image interpretation report database 101.

More specifically, the image interpretation determining unit 104 compares the result of input to the doctor's image findings entry area 31 obtained from the image interpretation obtaining unit 103 with the information of the definitive diagnosis 24 of the interpreted image 20 obtained from the image interpretation report database 101. The image interpretation determining unit 104 determines that the image interpretation is correct when the both match each other, and determines that the image interpretation is incorrect (a misdiagnosis was made) when the both do not match each other.

The learning content attribute selecting unit 105 selects the attribute of a learning content to be presented to the doctor, based on (i) the image interpretation and the image interpretation time obtained from the image interpretation obtaining unit 103 and (ii) the result of the determination on the correctness/incorrectness of the image interpretation obtained from the image interpretation determining unit 104. In addition, the learning content attribute selecting unit 105 notifies the attribute of the selected learning content to the output unit 107. The method of selecting the learning content having the attribute is described in detail later. Here, the attributes of learning contents are described.

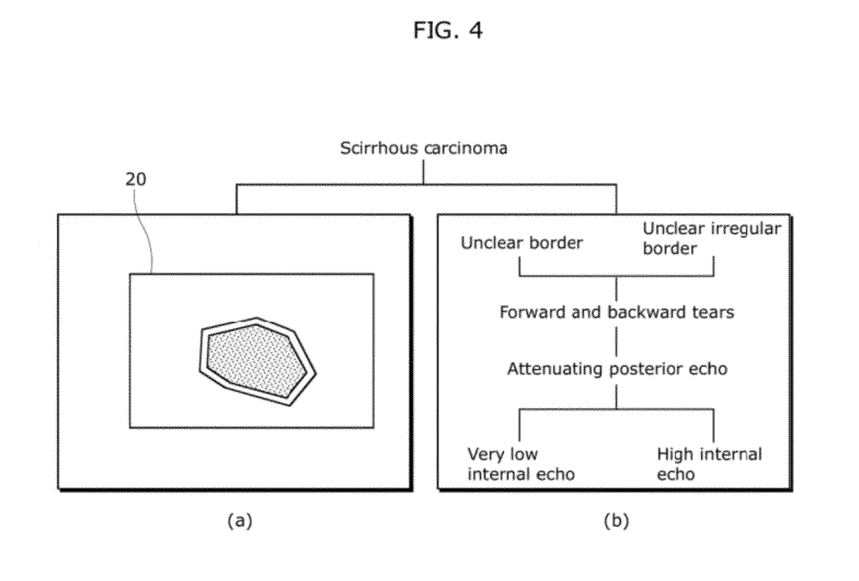

The attributes of the learning contents are classified into two types of identification information items assigned to contents for learning methods of accurately diagnosing cases. More specifically, the two types of attributes of learning contents are an image pattern attribute and a diagnosis flow attribute. A learning content assigned with an image pattern attribute is a content related to a representative interpreted image 20 associated with a disease name. On the other hand, a learning content assigned with a diagnosis flow attribute is a content related to a diagnosis flow associated with a disease name. FIG. 4 is a diagram of an exemplary content having an image pattern attribute and an exemplary content having a diagnosis flow attribute which are associated with “Disease name: scirrhous carcinoma”. As shown in (a) of FIG. 4, the content 40 having an image pattern attribute is an interpreted image 20 showing a typical example of scirrhous carcinoma. In addition, as shown in (b) of FIG. 4, the content 41 having a diagnosis flow attribute is a flowchart for diagnosing scirrhous carcinoma. For example, the diagnosis flow in (b) of FIG. 4 shows that scirrhous carcinoma is suspicious when the following features are found: an “Unclear border” or a “Clear and irregular border”, “Forward and backward tears”, an “Attenuating posterior echo”, a “Very low internal echo”, and a “High internal echo”.

The reason why learning contents are classified into the two types of attributes is described below.

Misdiagnoses are made due to causes roughly divided into two types. The first cause is a wrong association between a case and a diagnosis flow memorized by a doctor. The second cause is a wrong association between a case and image patterns memorized by a doctor.

The reason why these causes of misdiagnoses are classified into the above two types stems from the fact that the process for learning an image interpretation technique are divided into two stages.

A doctor in the first half of the learning process firstly makes determinations on the respective diagnosis items for the interpreted image 20, and makes a definitive diagnosis by combining the results of determinations on the respective diagnosis items with reference to the diagnosis flow. In this way, the doctor not skilled in image interpretation refers to the diagnosis flow for each of the diagnosis items, and thus the image interpretation time is long. The doctor enters into the second half of the learning process after finishing the first half of the learning process. A/The doctor in the second half of the learning process firstly makes determinations on the respective diagnosis items, pictures typical image patterns associated with the names of possible diseases, and immediately makes a diagnosis with reference to the pictured image patterns. The image interpretation time required by the doctor in the second half of the learning process is comparatively shorter than the image interpretation time required by the doctor in the first half of the learning process. This is because a doctor who have experienced a many number of image interpretations of the same case well knows the diagnosis flow, and does not need to refer to the diagnosis flow. For this reason, the doctor in the second half of the learning process makes a diagnosis based mainly on the image patterns.

In other words, misdiagnoses due to wrong image interpretations are made when wrong knowledge is obtained in the different stages of the learning process. Therefore, the image interpretation training apparatus 100 determines whether a misdiagnosis was made due to “a wrong association between a case and a diagnosis flow (a diagnosis flow attribute)” or “a wrong association between a case and image patterns (an image pattern attribute)”. Furthermore, the image interpretation training apparatus 100 can provide the learning content corresponding to the cause of the misdiagnosis by the doctor by providing the doctor with the learning content having the learning content attribute corresponding to the cause of the misdiagnosis.

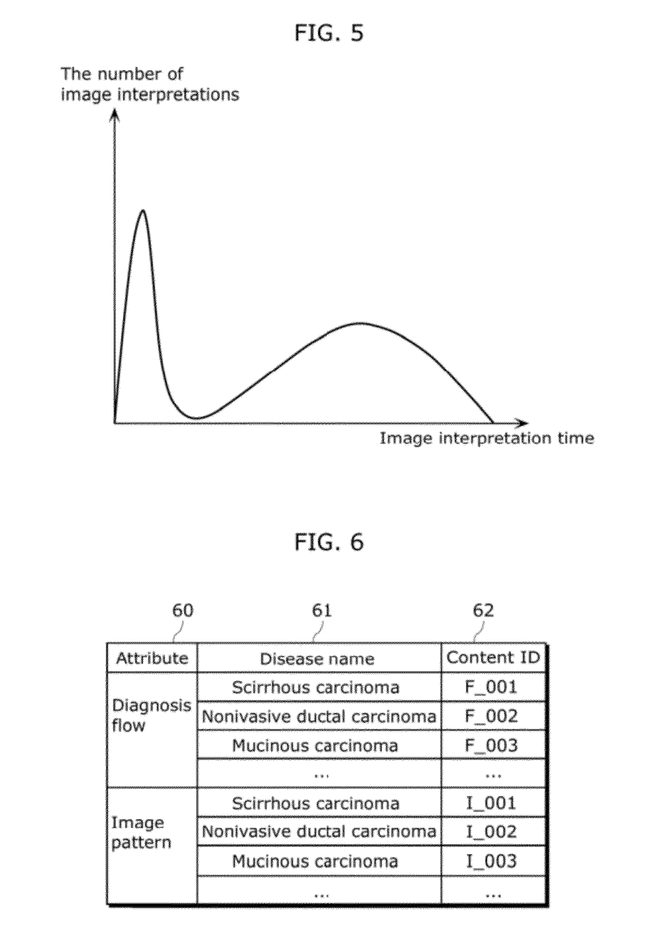

The above-described two diagnosis processes can be classified using image interpretation times. FIG. 5 is a diagram of a typical example of a histogram of image interpretation times in a radiology of a hospital. In FIG. 5, the frequency (the number of image interpretations) in the histogram is approximated using a curved waveform. As shown in FIG. 5, the waveform in the histogram has two peaks. It is possible to determine that the peak at the side of short image interpretation time shows diagnoses based on image patterns, and that the peak at the side of long image interpretation time shows diagnoses based on determinations using diagnosis flows. As described above, the difference in these temporal characteristics are made due to the difference between the stages of the process for learning image interpretation. Specifically, the difference is mainly due to whether a diagnosis flow is referred to or not.

It is possible to classify the causes of misdiagnoses made by doctors based on such characteristics in image interpretation time. For example, in the case where a misdiagnosis is made as a result that a doctor interpreted images in a short image interpretation time A, the misdiagnosis indicates that the doctor made a determination based on wrong image patterns. Thus, there is a need to present right image patterns as a learning content which helps the doctor correct the wrong image patterns memorized by the doctor. On the other hand, in the case where a misdiagnosis is made as a result that a doctor interpreted images in a long image interpretation time B, the misdiagnosis indicates that the doctor made a determination according to a wrong diagnosis flow. Thus, there is a need to present a learning content which helps the doctor correct the wrong diagnosis flow memorized by the doctor.

In this way, it is possible to present the learning content corresponding to the cause of the misdiagnosis by presenting the learning content classified into the corresponding one of the two attributes. In this way, it is possible to reduce the time to search out the learning content by the doctor him/herself and the time to read unnecessary learning contents, and to thereby reduce the learning time required by the doctor.

Here, a return is made to the descriptions of the respective structural elements of the image interpretation training apparatus 100 shown in FIG. 1.

The learning content database 106 is a database which stores learning contents each related to a corresponding one of the two attributes that are the image pattern attribute and the diagnosis flow attribute which are selectively selected by the learning content attribute selecting unit 105. FIG. 6 is a diagram of an example of a learning content database 106. As shown in FIG. 6, the learning content database 106 includes a content attribute 60, a disease name 61, and content ID 62. The learning content database 106 includes content ID 62 in the form of a list which allows easy obtainment of the content ID 62 based on the content attribute 60 and the disease name 61. For example, in the case where the content attribute 60 has a diagnosis flow attribute, and the disease name 61 is scirrhous carcinoma, the content ID 62 of the learning content is F_{—}001. The learning content corresponding to the content ID 62 is stored in the learning content database 106. However, the learning content does not always need to be stored in the learning content database 106, and may be stored in, for example, a server outside.

The output unit 107 obtains the content ID associated with the content attribute selected by the learning content attribute selecting unit 105 and the name of the disease misdiagnosed by the doctor, with reference to the learning content database 106. In addition, the output unit 107 outputs the learning content corresponding to the obtained content ID to the output medium. The output medium is a monitor such as a liquid crystal display and a television receiver.

A description is given of operations by the image interpretation training apparatus 100 configured as described above.

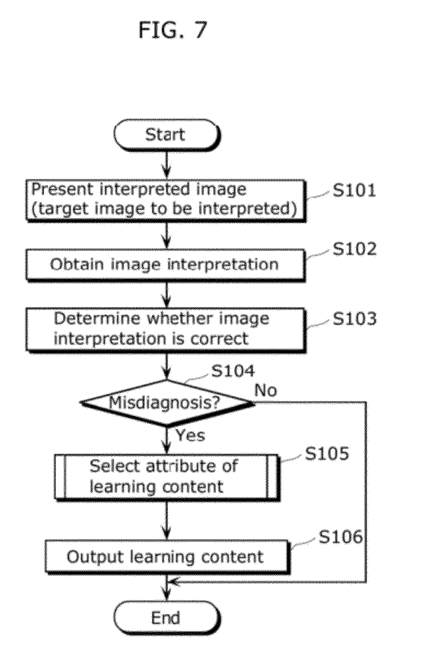

FIG. 7 is a flowchart of the overall processes executed by the image interpretation training apparatus 100.

First, the image presenting unit 102 obtains an interpreted image 20 as a target image to be interpreted in a diagnosis test, from the image interpretation report database 101. The image presenting unit 102 presents, to a doctor, the obtained interpreted image 20 (the target image to be interpreted) together with an entry form on which diagnosis items and findings on image for the interpreted image 20 are input, by displaying the interpreted image 20 and the entry form on a monitor such as a liquid crystal display and a television receiver (not shown) (Step S101). The interpreted image 20 as the target image may be selected by the doctor, or selected at random.

The image interpretation obtaining unit 103 obtains the image interpretation by the doctor on the interpreted image 20 presented by the image presenting unit 102. For example, the image interpretation obtaining unit 103 stores, in a memory or the like, the information input using a keyboard, a mouse, or the like. Subsequently, the image interpretation obtaining unit 103 notifies the obtained input to the image interpretation determining unit 104 and the learning content attribute selecting unit 105 (Step S102). More specifically, the image interpretation obtaining unit 103 obtains, from the image presenting unit 102, information input to the diagnosis item entry area 30 and the image findings entry area 31. In addition, the image interpretation obtaining unit 103 obtains image interpretation time.

The image interpretation determining unit 104 compares the image interpretation by the doctor obtained from the image interpretation obtaining unit 103 with the image interpretation information 21 stored in the image interpretation report database 101, with reference to the image interpretation report database 101. The image interpretation determining unit 104 determines whether the image interpretation by the doctor is correct or incorrect based on the comparison result (Step S103). More specifically, the image interpretation determining unit 104 compares the result of input to the doctor's image findings entry area 31 obtained from the image interpretation obtaining unit 103 with the information of the definitive diagnosis 24 of the interpreted image 20 obtained from the image interpretation report database 101. The image interpretation determining unit 104 determines that the image interpretation is correct when the both match each other, and determines that the image interpretation is incorrect (a misdiagnosis was made) when the both do not match each other. For example, in the case where the doctor's image findings input obtained in Step S102 is “scirrhous carcinoma” and the definitive diagnosis obtained from the image interpretation report database 101 is also “scirrhous carcinoma”, the image interpretation determining unit 104 determines that no misdiagnosis was made (the image interpretation is correct), based on the matching. In contrast, in the case where the doctor's image findings input obtained in Step S102 is “scirrhous carcinoma” and the definitive diagnosis obtained from the image interpretation report database 101 is a disease other than “scirrhous carcinoma”, the image interpretation determining unit 104 determines that a misdiagnosis was made, based on the mismatching.

Here, if a plurality of diagnoses (disease names) is obtained in Step S102, the image interpretation determining unit 104 may determine that the image interpretation is correct when one of the diagnoses matches the definitive diagnosis obtained from the image interpretation report database 101.

In the case where the learning content attribute selecting unit 105 obtains the determination that the diagnosis is a misdiagnosis from the image interpretation determining unit 104 (Yes in Step S104), the learning content attribute selecting unit 105 obtains, from the image interpretation obtaining unit 103, the results of input to the image findings entry area 31 and the image interpretation time. Furthermore, the learning content attribute selecting unit 105 selects the attribute of the learning content based on the image interpretation time, and notifies the attribute of the selected learning content to the output unit 107 (Step S105). The learning content attribute selecting process (Step S105) is described in detail later.

Lastly, the output unit 107 obtains the content ID associated with the learning content attribute selected by the learning content attribute selecting unit 105 and the name of the disease misdiagnosed by the doctor, with reference to the learning content database 106. Furthermore, the output unit 107 obtains the learning content corresponding to the obtained content ID from the learning content database 106, and outputs the learning content to the output medium (Step S106).

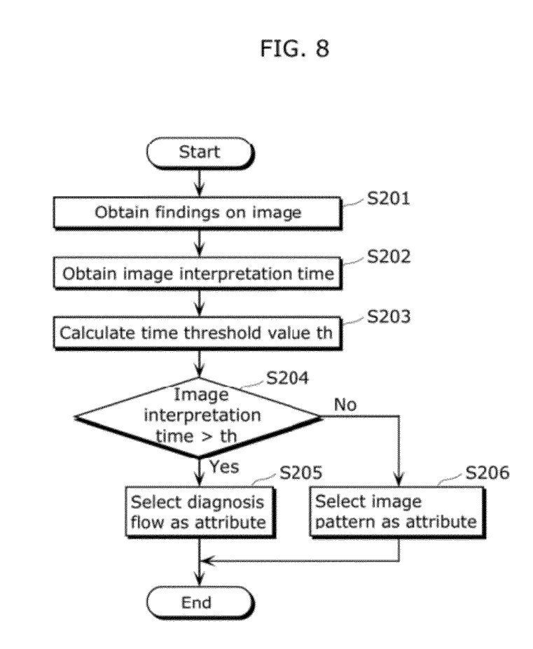

The learning content attribute selecting process (Step S105 in FIG. 7) is described in detail here. FIG. 8 is a flowchart of details of the learning content attribute selecting process (Step S105 in FIG. 7) performed by the learning content attribute selecting unit 105.

Hereinafter, the method of selecting a learning content attribute based on an image interpretation time required by a doctor is described with reference to FIG. 8.

First, the learning content attribute selecting unit 105 obtains image findings input by the doctor, from the image interpretation obtaining unit 103 (Step S201).

The learning content attribute selecting unit 105 obtains an image interpretation time required by the doctor, from the image interpretation obtaining unit 103 (Step S202). Here, the doctor's image interpretation time may be measured using a timer provided inside the image interpretation training apparatus 100. For example, the user presses a start button displayed on an image screen to start an image interpretation of a target image to be interpreted (when the target image is presented thereon), and the user presses an end button displayed on the image screen to end the image interpretation. The learning content attribute selecting unit 105 may obtain, as the image interpretation time, time measured by the timer, that is, the time when the start button is pressed to when the end button is pressed.

The learning content attribute selecting unit 105 calculates a threshold value for the image interpretation time for determining the attribute of the learning content (Step S203). An exemplary method for calculating the threshold value is to generate a histogram of image interpretation times stored as data of image interpretation times in the image interpretation report database 101, and calculate the threshold value for the image interpretation time according to the discriminant threshold selection method (see Non-patent Literature (NPL): “Image Processing Handbook”, pp. 278, SHOKODO, 1992). In this way, it is possible to set the threshold value for a trough located between two peaks in the histogram as shown in FIG. 5.

It is also possible to calculate a threshold value for the image interpretation time for each of the names of diseases diagnosed by doctors. The occurrence frequency of diagnosis flows or the occurrence frequency of cases are different from body portions that are diagnosis targets or the names of the diseases. For this reason, the respective image interpretation times may also vary. For example, in the case of a diagnosis using ultrasound images showing a mammary gland, examples of the names of diseases which require short diagnosis flows are part of scirrhous carcinoma and noninvasive ductal carcinoma. The names of these diseases can be determined based only on the border appearances of the tumors, and thus the times required to determine the cases are comparatively shorter than the times required to determine the names of other diseases. On the other hand, in the case of a diagnosis using ultrasound images showing a mammary gland, examples of the names of diseases which require long diagnosis flows are part of cyst and mucinous carcinoma. The names of these diseases can be determined using the shapes and the depth-width ratios of tumors, in addition to the border appearances of the tumors. Thus, the image interpretation times for these cases are longer than the part of scirrhous carcinoma and noninvasive ductal carcinoma.

In addition, image interpretation times vary depending on the occurrence frequencies of the names of diseases. For example, the occurrence frequency of “scirrhous carcinoma” in mammary gland diseases is approximately 30 percent, while the occurrence frequency of “encephaloid carcinoma” is approximately 0.5 percent. These cases having a high occurrence frequency frequently appear clinically. Thus, it does not take long time required by doctors for diagnosing such cases, and the image interpretation times are reduced more significantly than the image interpretation times for cases having a low occurrence frequency.

For this reason, it is possible to increase the accuracy in attribute classification by calculating a threshold value for each body portion or for each disease name.

In addition, it is possible to calculate the threshold value for the image interpretation time in synchronization with update of the image interpretation report database 101, and store the calculated threshold value in the image interpretation report database 101. Here, this threshold value calculation may be performed by either the learning content attribute selecting unit 105 or another processing unit. This enables a doctor to skip calculating a threshold value when inputting data about a diagnosis item. For this reason, it is possible to reduce the processing time required by the image interpretation training apparatus 100, and to present the learning content to the doctor in a shorter time.

The learning content attribute selecting unit 105 determines whether or not the doctor's image interpretation time obtained in Step S202 is longer than the threshold value calculated in Step S203 (Step S204). When the image interpretation time is longer than the threshold value (Yes in Step S204), the learning content attribute selecting unit 105 selects a diagnosis flow attribute as the attribute of the learning content (Step S205). On the other hand, when the image interpretation time is shorter than or equal to the threshold value (No in Step S204), the learning content attribute selecting unit 105 selects an image pattern attribute as the attribute of the learning content (Step S206).

When the above-described Steps S201 to S206 are executed, the learning content attribute selecting unit 105 can select the attribute of the learning content according to the cause of the misdiagnosis by the doctor.

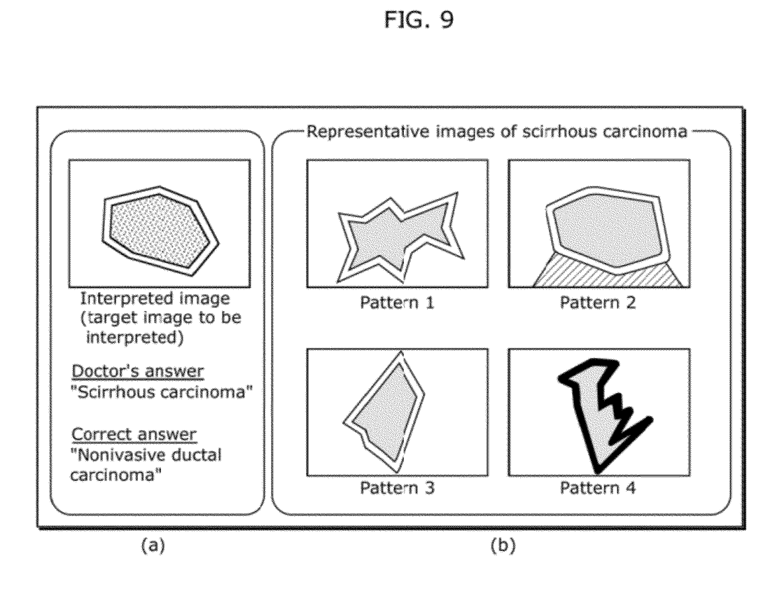

FIG. 9 is a diagram showing an example of an image screen output from the output unit 107 to an output medium when the learning content attribute selecting unit 105 selects the image pattern attribute. As shown in (a) of FIG. 9, the output unit 107 presents the interpreted image based on which the doctor made the misdiagnosis, the doctor's image interpretation (the doctor's answer) and the definitive diagnosis (the correct answer). In addition, as shown in (b) of FIG. 9, the output unit 107 presents representative images associated with the disease name corresponding to the doctor's answer. When the image pattern attribute is selected, it is probable that the doctor well knows the diagnosis flow for “scirrhous carcinoma”. For this reason, the doctor makes diagnoses based mainly on image patterns, and thus the doctor made the misdiagnosis by making a mistake in associating with correct image patterns for “scirrhous carcinoma”. Thus, it is possible to enable the doctor to correct the wrong representative images for “scirrhous carcinoma” memorized by the doctor, by presenting the correct representative images for “scirrhous carcinoma” that is the doctor's answer.

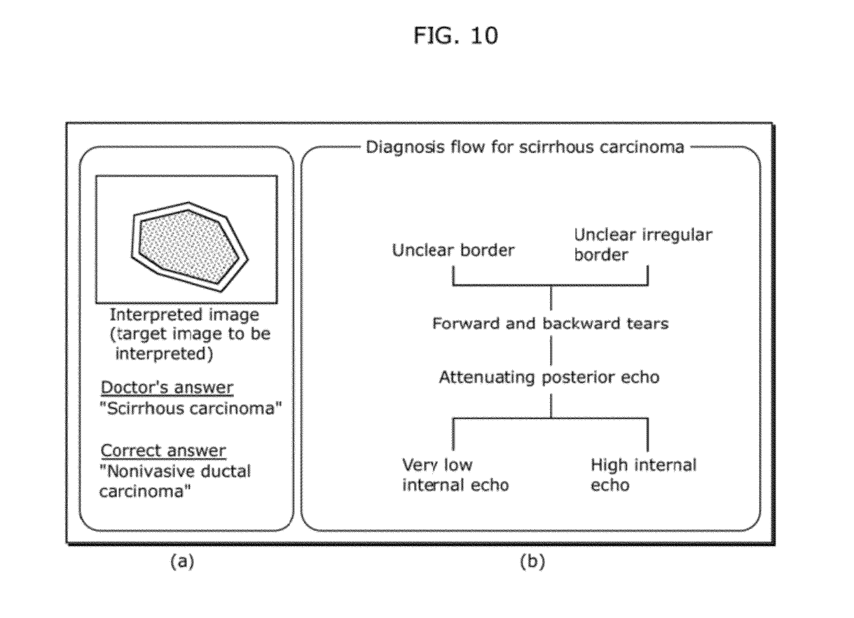

In addition, FIG. 10 is a diagram showing an example of an image screen output from the output unit 107 to the output medium when the learning content attribute selecting unit 105 selects the diagnosis flow attribute. As shown in (a) of FIG. 10 as with the case in (a) of FIG. 9, the output unit 107 presents the interpreted image based on which the misdiagnosis was made by the doctor, the doctor's image interpretation (the doctor's answer) and the definitive diagnosis (the correct answer). In addition to these presented, as shown in (b) of FIG. 10, the output unit 107 also presents diagnosis flows associated with the disease name corresponding to the doctor's answer. The example shown in FIG. 10 is a case where the misdiagnosis was made by making a mistake in associating with the correct diagnosis flow for “scirrhous carcinoma”. Thus, it is possible to enable the doctor to correct the wrong diagnosis flow for “scirrhous carcinoma” memorized by the doctor, by presenting the correct diagnosis flow for “scirrhous carcinoma” that is the doctor's answer.

As described above, when the above-described Steps S101 to S106 are executed, the image interpretation training apparatus 100 can provide the learning content according to the cause of the misdiagnosis by the doctor. For this reason, doctors can learn the image interpretation method efficiently in a reduced learning time.

In other words, the image interpretation training apparatus 100 according to this embodiment is capable of determining the cause of a misdiagnosis by a doctor using the image interpretation time required by the doctor, and automatically selecting the learning content according to the determined cause of the misdiagnosis. For this reason, the doctor can learn the image interpretation method efficiently without being provided with an unnecessary learning content.

### EMBODIMENT 2

Hereinafter, a description is given of an image interpretation training apparatus according to Embodiment 2 of the present disclosure.

As described above, the image interpretation training apparatus 100 according to Embodiment 1 classifies, using image interpretation times, the causes of misdiagnoses by doctors into two types of attributes that are “a diagnosis flow attribute” and “an image pattern attribute”, and presents a learning content having one of the attributes. In addition to this, the image interpretation training apparatus 200 according to Embodiment 2 emphasizes a misdiagnosis portion (that is the portion in relation to which the misdiagnosis was made) in the learning content that is provided to the doctor who made the misdiagnosis.

Conventional problems to be solved in this embodiment are described below. For example, if a doctor misdiagnoses “papillotubular carcinoma” as “scirrhous carcinoma” in making a diagnosis using ultrasonic images showing a mammary gland, the differences (different portions) between the diagnosis flow for “scirrhous carcinoma” and the diagnosis flow for “papillotubular carcinoma” are various and the differences relate to “internal echo”, “posterior echo”, “border appearance”, and so on. In order to learn the image interpretation method correctly, the doctor must differentiate all of these differences. However, simply presenting the diagnosis flows for scirrhous carcinoma and papillotubular carcinoma may allow an overlook of some of the differences between these two diagnosis flows, leaving a possibility that the image interpretation method is not learned correctly. In addition, searching for the differences between the two diagnosis flows increases the learning time, which results in a decrease in the learning efficiency.

The image interpretation training apparatus according to this embodiment is capable of presenting the learning content with emphasized portion(s) in relation to which the doctor made the misdiagnosis, and thereby increases the learning efficiency.

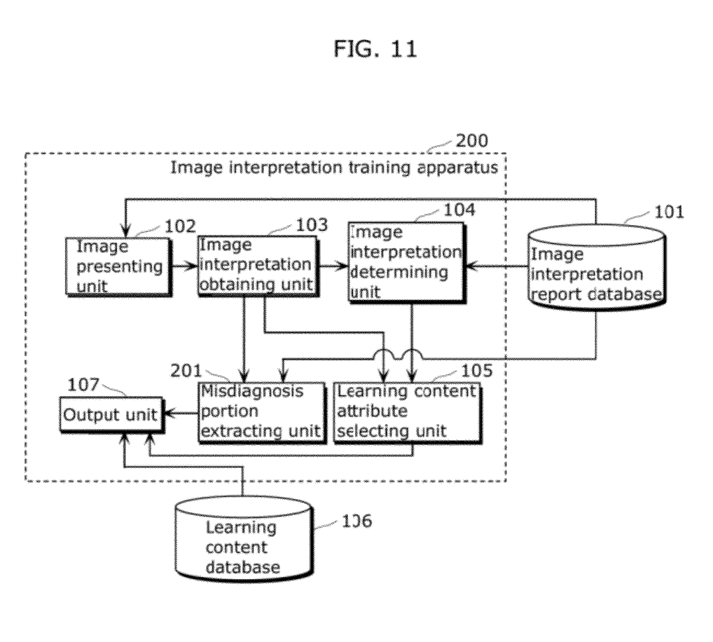

Hereinafter, structural elements of the image interpretation training apparatus according to this embodiment are described sequentially with reference to FIG. 11 for start.

### (Descriptions of Structural Elements of Embodiment 2)

FIG. 11 is a block diagram of unique functional elements of an image interpretation training apparatus 200 according to Embodiment 2 of the present disclosure. In FIG. 11, the same structural elements as in FIG. 1 are assigned with the same reference signs, and descriptions thereof are not repeated here.

The image interpretation training apparatus 200 includes: an image interpretation report database 101, an image presenting unit 102, an image interpretation obtaining unit 103, an image interpretation determining unit 104, a learning content attribute selecting unit 105, a learning content database 106, an output unit 107, and a misdiagnosis portion extracting unit 201.

The image interpretation training apparatus 200 shown in FIG. 11 is different from the image interpretation training apparatus 100 shown in FIG. 1 in the point of including the misdiagnosis portion extracting unit 201 which extracts the misdiagnosis portion in relation to which the misdiagnosis is made by the doctor, from the result of input to the diagnosis item entry area 30 obtained from the image interpretation obtaining unit 103.

The misdiagnosis portion extracting unit 201 includes a CPU, a memory which stores a program that is executed by the CPU, and so on. The misdiagnosis portion extracting unit 201 extracts the doctor's misdiagnosis portion, from the determination results input to the diagnosis item entry area 30 obtained from the image interpretation obtaining unit 103 and the item-based determination results 26 included in the image interpretation information 21 stored in the image interpretation report database 101. The method for extracting a misdiagnosis portion is described in detail later.

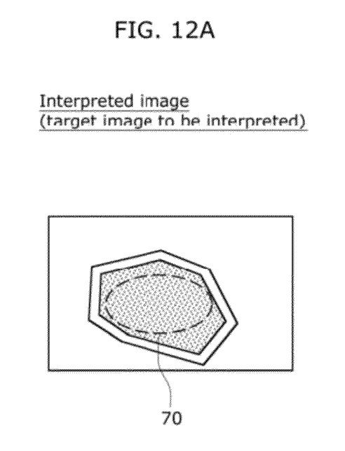

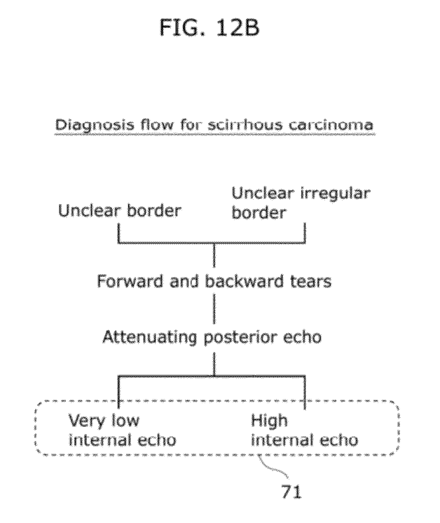

Here, a misdiagnosis portion is defined as a diagnosis item in relation to which a misdiagnosis is made in image interpretation processes or an area on a representative image. The image interpretation processes are roughly classified into two processes that are “visual recognition” and “diagnosis”. More specifically, a misdiagnosis portion in the visual recognition process corresponds to a particular image area on an interpreted image 20 (a target image to be interpreted), and a misdiagnosis portion in the diagnosis process corresponds to a particular diagnosis item in a diagnosis flow. Each of FIG. 12A and FIG. 12B shows an example of a misdiagnosis portion in (relation to) an ultrasonic image showing a mammary gland. In the case where the misdiagnosis portion extracting unit 201 extracts that a doctor's misdiagnosis portion corresponds to the internal echo appearance of a tumor, the misdiagnosis portion on the interpreted image 20 shows a misdiagnosis portion 70 that is the corresponding image area as shown in FIG. 12A. In addition, the misdiagnosis portion on the diagnosis flow as shown in FIG. 12B shows a misdiagnosis portion 71 corresponding to the misdiagnosis item in relation to which the misdiagnosis was made.

Explicitly presenting these misdiagnosis portions makes it possible to reduce the time to detect the misdiagnosis portions in relation to which the misdiagnosis was made by the doctor, and thus to increase the learning efficiency.

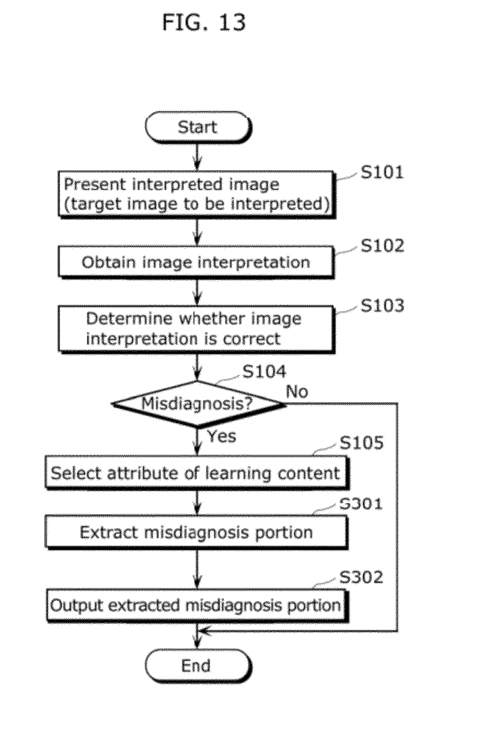

A flow of all processes executed by the image interpretation training apparatus 200 shown in FIG. 11 is described with reference to FIG. 13.

FIG. 13 is a flowchart of the overall processes executed by the image interpretation training apparatus 200. In FIG. 13, the same steps as the steps executed by the image interpretation training apparatus 100 according to Embodiment 1 shown in FIG. 7 are assigned with the same reference signs.

The image interpretation training apparatus 200 according to this embodiment is different from the image interpretation training apparatus 100 according to Embodiment 1 in the process of extracting the doctor's misdiagnosis portions from the determination results input to the diagnosis item entry area 30 obtained from the image interpretation obtaining unit 103. However, the other processes are the same as those performed by the image interpretation training apparatus 100 according to Embodiment 1. More specifically, in FIG. 13, processes from Steps S101 to S105 executed by the image interpretation training apparatus 200 are the same as the processes by the image interpretation training apparatus 100 according to Embodiment 1 shown in FIG. 7, and thus the same descriptions are not repeated here.

The misdiagnosis portion extracting unit 201 extracts the doctor's misdiagnosis portions using the determination results input to the diagnosis item entry area 30 obtained from the image interpretation obtaining unit 103 (Step S301).

As in the Step S106 shown in FIG. 7, the output unit 107 obtains the learning content from the learning content database 106, and outputs the learning content to the output medium. Here, the output unit 107 emphasizes misdiagnosis portions extracted by the misdiagnosis portion extracting unit 201 in the learning content, and outputs the learning content with the emphasized misdiagnosis portions (Step S302). Specific examples of how to emphasize the misdiagnosis portions are described later.

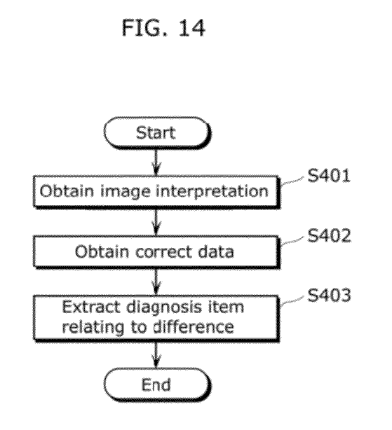

FIG. 14 is a flowchart of details of the process (Step S301 in FIG. 13) performed by the misdiagnosis portion extracting unit 201. Hereinafter, the method of extracting doctor's misdiagnosis portions is described with reference to FIG. 14.

First, the misdiagnosis portion extracting unit 201 obtains, from the image interpretation obtaining unit 103, the determination results input to the diagnosis item entry area 30 (Step S401).

The misdiagnosis portion extracting unit 201 obtains item-based determination results 26 including the same image findings 27 as the definitive diagnosis 24 on the interpreted image that is the target image in the diagnosis, from the image interpretation report database (Step S402).

The misdiagnosis portion extracting unit 201 extracts the diagnosis items in relation to which the determination results input by the doctor to the diagnosis item entry area 30 and obtained in Step S401 are different from the item-based determination results 26 obtained in Step S402 (Step S403). In other words, the misdiagnosis portion extracting unit 201 extracts, as misdiagnosis portions, these diagnosis items related to different determination results.

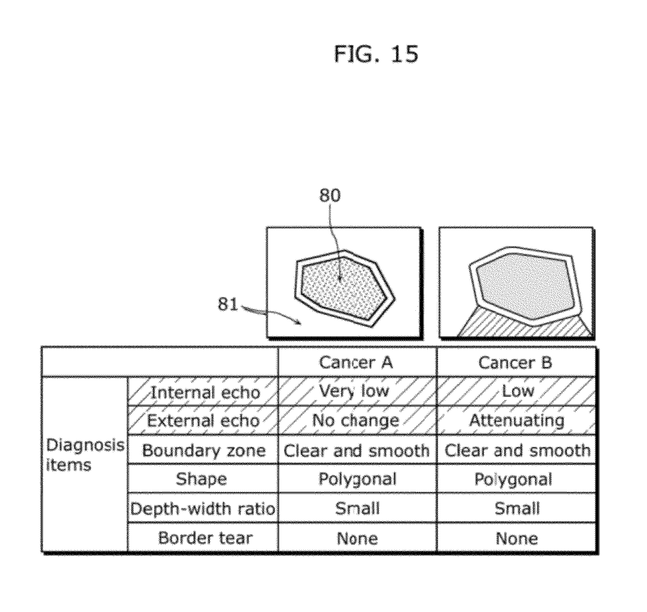

FIG. 15 shows representative images of “Cancer A” and “Cancer B” and examples of diagnosis items. Hereinafter, how to extract the differences relating to the diagnosis items is described with reference to FIG. 15. Assuming that a doctor misdiagnoses Cancer B as Cancer A from the target image although the correct answer is Cancer B. In this case, in order to determine the part of the diagnosis items in relation to which wrong knowledge were learned and the misdiagnosis as Cancer A was made, it is only necessary to extract the part of the diagnosis items in relation to which the determination results by the doctor who misdiagnosed Cancer B as Cancer A are different from the determination results showing Cancer B that is the correct answer. In the example of FIG. 15, the misdiagnosis portions that are extracted are internal echo 80 and posterior echo 81 which are diagnosis items in relation to which the determination results by the doctor who misdiagnoses Cancer B as Cancer A are different from the determination results showing Cancer B as the correct answer. For example, the internal echo 80 is extracted as one of the misdiagnosis portions because the determination result in the misdiagnosis as Cancer A is “Low” while the determination result in the diagnosis of Cancer B is “Very low”. In addition, the posterior echo 81, is extracted as the other misdiagnosis portion because the determination result in the misdiagnosis as Cancer A is “Attenuating” while the determination result in the diagnosis of Cancer B is “No change”.

When the processes of the above-described Steps S401 to S403 are executed, the misdiagnosis portion extracting unit 201 can extract the doctor's misdiagnosis portions.

A process (Step S302 in FIG. 13) by the output unit 107 is described taking a specific example.

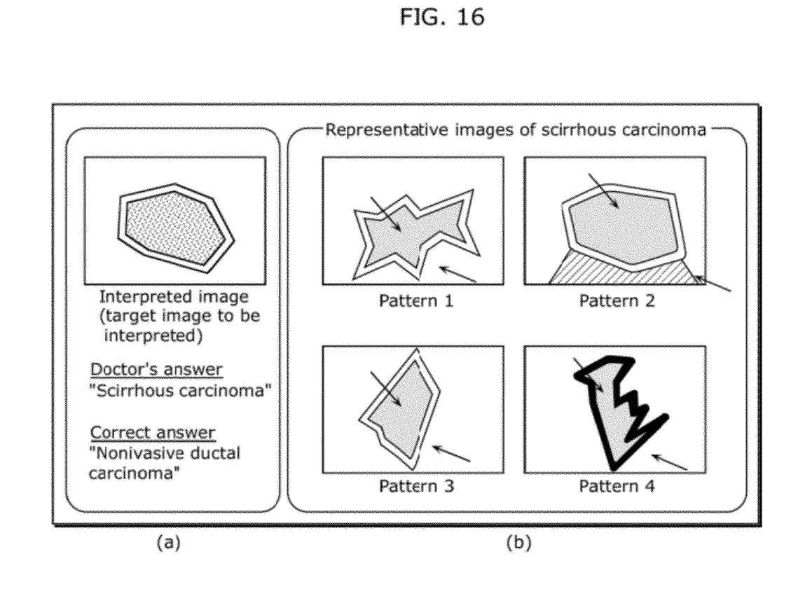

FIG. 16 is a diagram of an example of an image screen output to an output medium by an output unit 107 when a misdiagnosis portion is extracted by the misdiagnosis portion extracting unit 201. As shown in FIG. 16, the output unit 107 emphasizes, on a presented representative image associated with the name of the disease misdiagnosed by the doctor, image areas corresponding to the misdiagnosis portions that are the diagnosis items on which the determinations different from those in the correct case were made. In this case, the image areas emphasized using arrows on the presented image are image areas corresponding to the “posterior echo” and the “internal echo” that are diagnosis items in relation to which determination results are different between “scirrhous carcinoma” and “noninvasive ductal carcinoma”. In this way, it is possible to automatically present image areas recognized wrongly by the doctor when presenting the representative image of “scirrhous carcinoma” that is the doctor's answer. Here, the position information of the image areas to be emphasized may be recorded in the learning content database 106 in association with the diagnosis items in advance. Based on the misdiagnosis portions (diagnosis items) extracted by the misdiagnosis portion extracting unit 201, the output unit 107 obtains the position information of the image areas to be emphasized with reference to the learning content database 106, and emphasizes the image areas based on the obtained position information on the presented image. Here, the position information of the image areas to be emphasized may be recorded in a place other than the learning content database 106. Alternatively, the position information of the image areas to be emphasized does not always need to be stored anywhere. In this case, the output unit 107 may detect the image areas to be emphasized by performing image processing.

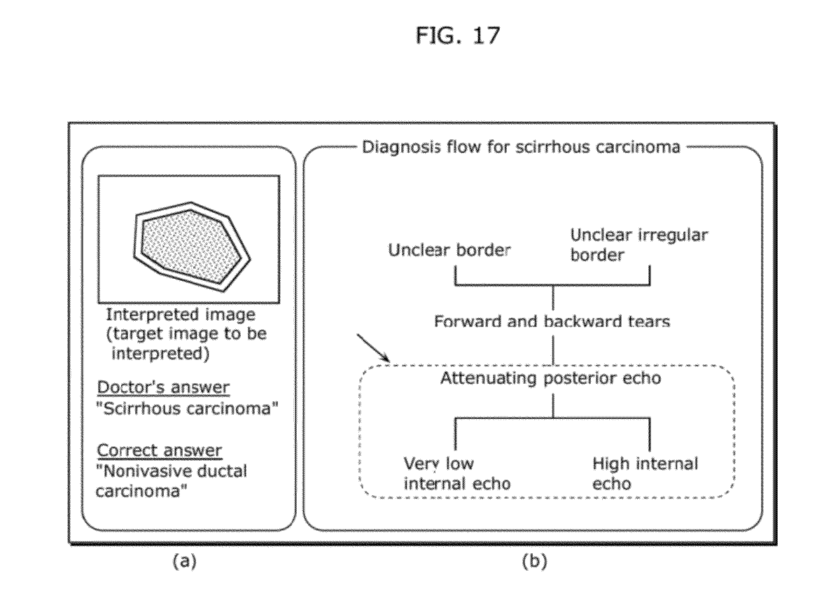

FIG. 17 is a diagram of an example of an image screen output to an output medium by an output unit 107 when misdiagnosis portions are extracted by the misdiagnosis portion extracting unit 201. As shown in FIG. 17, the output unit 107 presents, in the diagnosis flow associated with the name of the disease misdiagnosed by the doctor, the parts that are the diagnosis items on which determinations different from those in the case as the correct answer were made. Also in this case as in the case of FIG. 16, the part emphasized by being enclosed using broken lines in the presented diagnosis flow is the part corresponding to the “posterior echo” and the “internal echo” that are diagnosis items on which determination results different between “scirrhous carcinoma” and “noninvasive ductal carcinoma” were obtained. In this way, it is possible to automatically present the diagnosis flow part recognized wrongly by the doctor when presenting the diagnosis flow for “scirrhous carcinoma” that is the doctor's answer.

When the processes of the above-described Steps S101 to S106, and Step S301 are executed, the image interpretation training apparatus 200 can present the doctor's misdiagnosis portions to the output unit 107, which reduces overlooks of misdiagnosis portions and search time, and thereby increases the learning efficiency.

Image interpretation training apparatus according to some exemplary embodiments of the present disclosure have been described above. However, these exemplary embodiments do not limit the inventive concept, the scope of which is defined in the appended Claims and their equivalents. Those skilled in the art will readily appreciate that various modifications may be made in these exemplary embodiments and other embodiments may be made by arbitrarily combining some of the structural elements of different exemplary embodiments without materially departing from the principles and spirit of the inventive concept, the scope of which is defined in the appended Claims and their equivalents.

It is to be noted that the essential structural elements of the image interpretation training apparatuses according to the exemplary embodiments of the present disclosure is the image presenting unit 102, the image interpretation obtaining unit 103, the image interpretation determining unit 104, and the learning content attribute selecting unit 105, and that the other structural elements are not always required.

In addition, each of the above apparatuses may be configured as, specifically, a computer system including a microprocessor, a ROM, a RAM, a hard disk unit, a display unit, a keyboard, a mouse, and so on. A computer program is stored in the RAM or hard disk unit. The respective apparatuses achieve their functions through the microprocessor's operations according to the computer program. Here, the computer program is configured by combining plural instruction codes indicating instructions for the computer, so as to allow execution of predetermined functions.

Furthermore, a part or all of the structural elements of the respective apparatuses may be configured with a single system-LSI (Large-Scale Integration). The system-LSI is a super-multi-function LSI manufactured by integrating constituent units on a single chip, and is specifically a computer system configured to include a microprocessor, a ROM, a RAM, and so on. A computer program is stored in the RAM. The system-LSI achieves its/their function(s) through the microprocessor's operations according to the computer program.

Furthermore, a part or all of the structural elements constituting the respective apparatuses may be configured as an IC card which can be attached to and detached from the respective apparatuses or as a stand-alone module. The IC card or the module is a computer system configured from a microprocessor, a ROM, a RAM, and so on. The IC card or the module may also be included in the aforementioned super-multi-function LSI. The IC card or the module achieves its/their function(s) through the microprocessor's operations according to the computer program. The IC card or the module may also be implemented to be tamper-resistant.

In addition, the respective apparatuses according to the present disclosure may be realized as methods including the steps corresponding to the unique units of the apparatuses. Furthermore, these methods according to the present disclosure may also be realized as computer programs for executing these methods or digital signals of the computer programs.

Such computer programs or digital signals according to the present disclosure may be recorded on computer-readable non-volatile recording media such as flexible discs, hard disks, CD-ROMs, MOs, DVDs, DVD-ROMs, DVD-RAMs, BDs (Blu-ray Disc (registered trademark)), and semiconductor memories. In addition, these methods according to the present disclosure may also be realized as the digital signals recorded on these non-volatile recording media.

Furthermore, these methods according to the present disclosure may also be realized as the aforementioned computer programs or digital signals transmitted via a telecommunication line, a wireless or wired communication line, a network represented by the Internet, a data broadcast, and so on.

The apparatuses (or computers or a computer system) according to the present disclosure may also be implemented as a computer system including a microprocessor and a memory, in which the memory stores the aforementioned computer program and the microprocessor operates according to the computer program. Here, software for realizing the respective image interpretation training apparatuses (misdiagnosis cause detecting apparatuses) is a program as indicated below.

This program is for causing a computer to execute: presenting, to a user, a target image to be interpreted that is used to make an image-based diagnosis on a case and is paired with a definitive diagnosis in an image interpretation report, the target image being one of interpreted images used for image-based diagnoses and respectively included in image interpretation reports; obtaining a first image interpretation that is an interpretation of the target image by the user and an image interpretation time that is a time period required by the user for the interpretation of the target image, the first image interpretation including an indication of a name of the disease; determining whether the first image interpretation obtained in the obtaining is correct or incorrect by comparing the first image interpretation with the definitive diagnosis on the target image; and executing, when the first image interpretation is determined to be incorrect in the determining, at least one of: (a) a first selection process for selecting an attribute of a first learning content to be presented to the user when the image interpretation time obtained in the obtaining is longer than a threshold value, the first learning content being for learning a diagnosis flow for the case having the disease name indicated by the first image interpretation; and (b) a second selection process for selecting an attribute of a second learning content to be presented to the user when the image interpretation time obtained in the obtaining is shorter than or equal to the threshold value, the second learning content being for learning an image pattern of the case having the disease name indicated by the first image interpretation.

Furthermore, it is also possible to execute another independent computer system by transmitting the programs or the digital signals recorded on the aforementioned non-volatile recording media, or by transmitting the programs or digital signals via the aforementioned network and the like.

Furthermore, these exemplary embodiments and variations may be arbitrarily combined.

As described above, those skilled in the art will readily appreciate that various modifications and variations are possible without materially departing from the principles and spirit of the inventive concept, the scope of which is defined in the appended Claims and their equivalents.

### INDUSTRIAL APPLICABILITY

One or more exemplary embodiments of the present disclosure are applicable to, for example, devices each of which detects the cause of a misdiagnosis based on an input of image interpretation by a doctor.

1. A misdiagnosis cause detecting apparatus comprising:
an image, presenting unit configured to present, to a user, a target image to be interpreted that is used to make an image-based diagnosis on a case and is paired with a definitive diagnosis in an image interpretation report, the target image being one of interpreted images used for image-based diagnoses and respectively included in image interpretation reports;
an image interpretation obtaining unit configured to obtain a first image interpretation that is an interpretation of the target image by the user and an image interpretation time that is a time period required by the user for the interpretation of the target image, the first image interpretation including an indication of a name of the disease;
an image interpretation determining unit configured to determine whether the first image interpretation obtained by said image interpretation obtaining unit is correct or incorrect by comparing the first image interpretation with the definitive diagnosis on the target image; and
a learning content attribute selecting unit configured to execute, when the first image interpretation is determined to be incorrect by said image interpretation determining unit, at least one of:
(a) a first selection process for selecting an attribute of a first learning content to be presented to the user when the image interpretation time obtained by said image interpretation obtaining unit is longer than a threshold value, the first learning content being for learning a diagnosis flow for the case having the disease name indicated by the first image interpretation; and
(b) a second selection process for selecting an attribute of a second learning content to be presented to the user when the image interpretation time obtained by said image interpretation obtaining unit is shorter than or equal to the threshold value, the second learning content being for learning an image pattern of the case having the disease name indicated by the first image interpretation.

2. The misdiagnosis cause detecting apparatus according to claim 1,
wherein the image interpretation report further includes a second image interpretation that is a previously-made image interpretation of the target image, and
said image presenting unit is configured to present, to the user, the target image included in the image interpretation report that includes the definitive diagnosis and the second image interpretation that match each other.

3. The misdiagnosis cause detecting apparatus according to claim 1, further comprising
an output unit configured to obtain, from a learning content database, one of the first learning content and the second learning content which has the attribute selected by said learning content attribute selecting unit for the case having the disease name indicated by the first image interpretation, and output the obtained first or second learning content, the learning content database storing first learning contents for learning diagnosis flows for cases and second learning contents for learning image patterns of the cases such that the first learning contents are associated with cases and the second learning contents are associated with the cases.

4. The misdiagnosis cause detecting apparatus according to claim 1,
wherein the image interpretation report further includes results of determinations made on diagnosis items, and
said image interpretation obtaining unit is further configured to obtain the determination results on the respective diagnosis items made by the user,
said misdiagnosis cause detecting apparatus further comprising
a misdiagnosis portion extracting unit configured to extract each of at least one of the diagnosis items which corresponds to a misdiagnosis portion in the first or second learning content and is related to a difference of one of the determination results obtained by said image interpretation obtaining unit with respect to a corresponding one of the determination results included in the image interpretation report.

5. The misdiagnosis cause detecting apparatus according to claim 4, further comprising
an output unit configured to obtain, from a learning content database, one of the first learning content and the second learning content which has the attribute selected by said learning content attribute selecting unit for the case having the disease name indicated by the first image interpretation, emphasize, in the obtained first or second learning content, the misdiagnosis portion corresponding to the diagnosis item extracted by said misdiagnosis portion extracting unit, and output the obtained first or second learning content with the emphasized portion the learning content database storing first learning contents for learning diagnosis flows for cases and second learning contents for learning image patterns of the cases such that the first learning contents are associated with cases and the second learning contents are associated with the cases.

6. The misdiagnosis cause detecting apparatus according to claim 1,
wherein the threshold value is associated one-to-one with the case having the disease name indicated by said first image interpretation.

7. A misdiagnosis cause detecting method performed by a computer, said method comprising,
presenting, to a user, a target image to be interpreted that is used to make an image-based diagnosis on a case and is paired with a definitive diagnosis in an image interpretation report, the target image being one of interpreted images used for image-based diagnoses and respectively included in image interpretation reports;
obtaining a first image interpretation that is an interpretation of the target image by the user and an image interpretation time that is a time period required by the user for the interpretation of the target image, the first image interpretation including an indication of a name of the disease;
determining whether the first image interpretation obtained in said obtaining is correct or incorrect by comparing the first image interpretation with the definitive diagnosis on the target image; and
executing, when the first image interpretation is determined to be incorrect in said determining, at least one of:
(a) a first selection process for selecting an attribute of a first learning content to be presented to the user when the image interpretation time obtained in said obtaining is longer than a threshold value, the first learning content being for learning a diagnosis flow for the case having the disease name indicated by the first image interpretation; and
(b) a second selection process for selecting an attribute of a second learning content to be presented to the user when the image interpretation time obtained in said obtaining is shorter than or equal to the threshold value, the second learning content being for learning an image pattern of the case having the disease name indicated by the first image interpretation.

8. A non-transitory computer-readable recording medium for use in a computer, said recording medium having a computer program recorded thereon for causing the computer to execute:
presenting, to a user, a target image to be interpreted that is used to make an image-based diagnosis on a case and is paired with a definitive diagnosis in an image interpretation report, the target image being one of interpreted images used for image-based diagnoses and respectively included in image interpretation reports;
obtaining a first image interpretation that is an interpretation of the target image by the user and an image interpretation time that is a time period required by the user for the interpretation of the target image, the first image interpretation including an indication of a name of the disease;
determining whether the first image interpretation obtained in said obtaining is correct or incorrect by comparing the first image interpretation with the definitive diagnosis on the target image; and
executing, when the first image interpretation is determined to be incorrect in said determining, at least one of:
(a) a first selection process for selecting an attribute of a first learning content to be presented to the user when the image interpretation time obtained in said obtaining is longer than a threshold value, the first learning content being for learning a diagnosis flow for the case having the disease name indicated by the first image interpretation; and
(b) a second selection process for selecting an attribute of a second learning content to be presented to the user when the image interpretation time obtained in said obtaining is shorter than or equal to the threshold value, the second learning content being for learning an image pattern of the case having the disease name indicated by the first image interpretation.
